(19) United States
(12) Patent Application Publication
(10) Pub. No.: US 2005/0178867 A1
(43) Pub. Date: Aug. 18, 2005

(54) System and method for winding a defect-free optical fiber on a bobbin

(76) Inventors: Nathan Raz, Haifa (IL); Yehuda Gabai, Shlomi (IL)

Correspondence Address: Mark M Friedman;Bill Polkinhorn, 9003 Florin Way, Upper Marlboro, MD, 20772, US

(21) Appl. No.: 10/512,697

(22) PCT Filed: Jan. 19, 2004
(86) PCT No.: PCT/IL04/00052

(30) Foreign Application Priority Data
Jan. 19, 2003 (IL) 154026

(51) Int. Cl. B65H 55/04

(52) U.S. Cl. 242/177

(57) ABSTRACT

A system and method for winding a defect-free active optical fiber on a bobbin comprises a dummy layer serving as a base layer on the bobbin. The dummy layer can be wound on either a smooth or a grooved external surface of the bobbin, and the active fiber is wound over it, being guided by the structure of the dummy layer.

### FIELD AND BACKGROUND OF THE INVENTION

The present invention relates to optical fibers used in optically guided airborne bodies such as air-to-ground or ground-to-ground missiles. More specifically, the present invention relates to an apparatus for winding such a fiber on a smooth bobbin.

Optical fiber dispensers are used for communication between a launcher, such as an airborne platform that carries the dispenser and from which the dispenser “pays out” the optical fiber, and a remotely operated object such as a remotely operated missile. The optical fiber is wound on a bobbin, which is normally pre-grooved on its external surface, the groove used to guide the winding of a first bottom layer of the fiber. A detailed description of a prior art dispenser is given for example in U.S. Pat. No. 5,607,532 to LoStracco, which is incorporated herein by reference. For proper, smooth and faultless functioning of the payout, it is necessary that throughout the payout operation the residual pack, i.e. that part of the optical fiber spool that is still on the bobbin, must not loosen so that each turn of fiber remains in place in its original, slightly tensioned state until payout. The payout may be quite rapid, with speeds higher than 20 m/sec.

An optical fiber is made of at least two different materials, a fused silica inner part which guides the light and an elastomer coating. During winding of the optical fiber on the bobbin, an adhesive is applied among the layers of the pack, and between the bottom layer and the bobbin. In this way, the individual turns of fiber in the pack are fixed to ensure that no loosening occurs prior and during the payout. The winding action and geometry may themselves cause problems such as optical losses due to micro-bends formed between crossing sections, pressure or tension.

FIG. 1 shows a typical prior art bobbin 10 with a wound fiber 20. The bobbin is normally a slightly conical tubular structure that includes a pre-grooved tube 22 having a front end 24 and an aft end 26, with an incline a of about 1-8° along its length axis 28 causing the aft end to have a slightly smaller diameter than the front end. The pre-grooved external surface of the tube includes a helical screw groove 30 for holding and guiding the winding of a first base-layer 32 of fiber 20. The grooves are defined by a pitch P (center-to-center distance of two adjacent grooves) and a depth D. Once the pitch is chosen, fiber 20 must have a slightly smaller (by a few micrometers) diameter to fit in. Thus, typical pre-grooved bobbins can accommodate only fibers of a certain diameter. The micro-bending is worse in the base layer, due to faults in the helical screw grooves.

During the winding action, additional fiber layers are wound in the grooves provided by the layer directly below. Thus, base layer 32 guides a second layer 36, the “valleys” between adjacent turns of fiber 20 in layer 32 serving as “grooves” for the second layer. A third layer 38 is wound in the grooves of second layer 36, a fourth layer 40 is wound in the grooves of third layer 38, etc. In addition, the first turn of each layer, e.g. first turn 42 of the fifth layer is recessed by a number of “skipped” turns 42 relative to the first turn of the layer directly below.

Since the micro-bending is worse in the base layer, critical failures in the optical fiber being payed-out usually start in the base layer. These vary from significant signal attenuation to complete breaks. Consequently, it would be highly advantageous to have a method and system for coiling an optical fiber on a bobbin that prevents micro-bending and other undesirable effects such as high attenuation in the base layer.

### SUMMARY OF THE INVENTION

The present invention is of a system and method that provides a defect-free, active (in the sense of useful for sensing and control purposes) optical fiber wound on a bobbin with minimal defects in its base layer. The defects, particularly micro-bendings, are reduced by providing a dummy layer functioning as a base layer. This dummy layer, not part of the active optical fiber, replaces the first layer of the active optical fiber as base layer. The fiber winding then starts atop of this dummy layer.

According to the present invention there is provided a system for winding a defect-free active optical fiber on a bobbin, comprising a bobbin tube having an external surface, and a dummy fiber layer overlaying the external surface and bound to the surface, whereby the dummy fiber layer serves as base layer for the active optical fiber.

According to the present invention there is provided a method for reducing winding-induced damage in an optical fiber wound on a bobbin having an external tubular surface, the method comprising the steps of winding a dummy fiber layer on the external tubular surface, the dummy layer serving as base layer for an active optical fiber, and winding the active optical fiber over the dummy layer, whereby the dummy fiber guides the active fiber winding.

### BRIEF DESCRIPTION OF THE DRAWINGS

The invention is herein described, by way of example only, with reference to the accompanying drawings, wherein:

FIG. 1 shows in cross-section a typical prior art bobbin with wound fiber;

FIG. 2 shows in cross section a preferred embodiment of a dummy layer according to the present invention;

FIG. 3 shows an active optical fiber spool wound on a dummy layer;

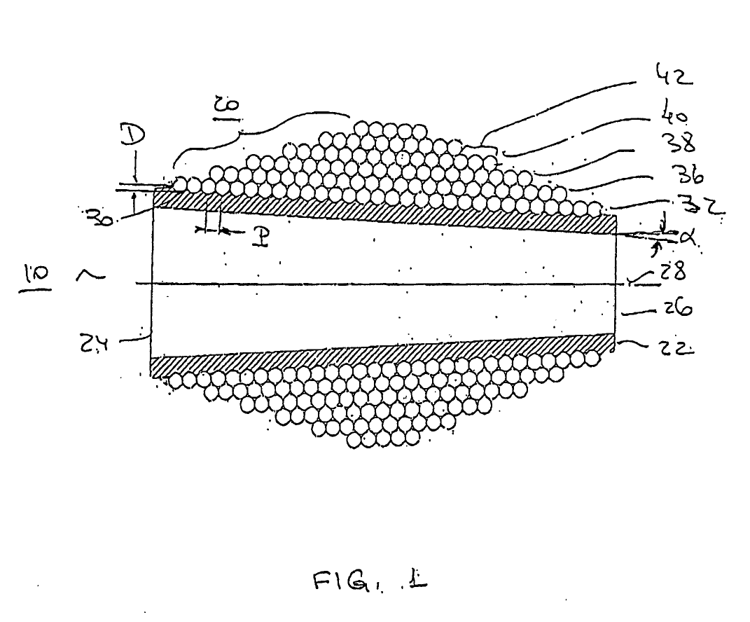

### DESCRIPTION OF THE PREFERRED EMBODIMENTS

The present invention is of method and system for winding a defect-free optical fiber on a bobbin that prevents micro-bending and other undesirable effects in the base layer. Specifically, the system of the present invention uses a dummy fiber layer instead of the first layer of an active optical fiber as the “base layer” in contact with the bobbin. The principles and operation of an improved transition section according to the present invention may be better understood with reference to the drawings and the accompanying description.

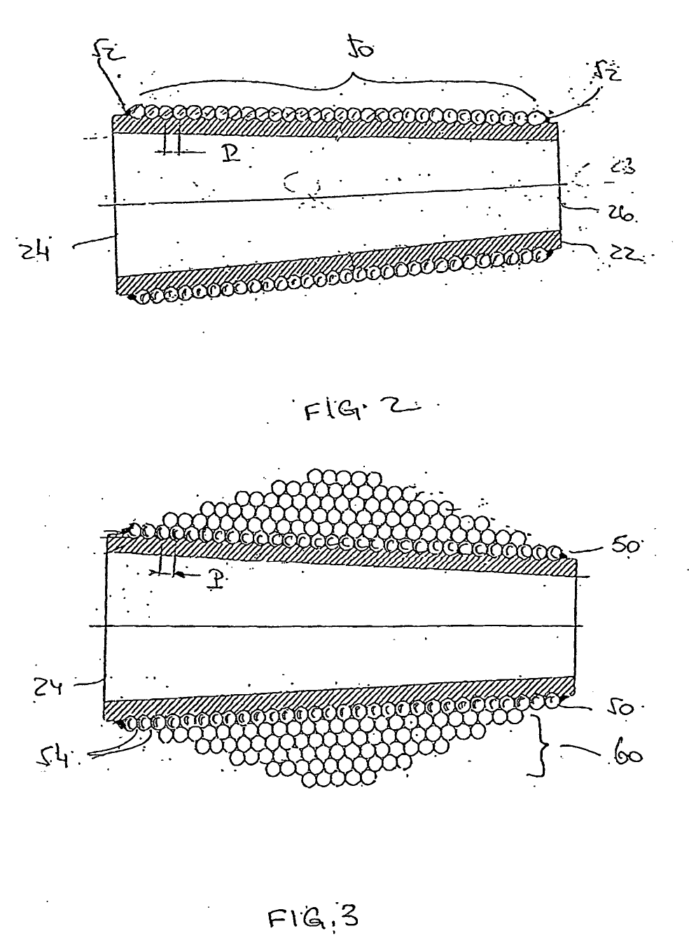

FIG. 2 shows in cross section a preferred embodiment of a bobbin having a dummy layer according to the present invention. A dummy layer 50, preferably made of the same fiber as an “active” fiber to be wound on top thereof, is wound on the external surface of a bobbin tube 22, preferably in a left-hand screw direction, starting at front end 24 and ending at aft end 26. End turns 52 of dummy layer 50 are secured to the tube preferably using fast curing adhesives, which are well known. The external surface of tube 22 may be pre-grooved, or preferably and advantageously, may be smooth, removing the need for the additional task of pre-grooving the tube. If the tube is pre-grooved, the diameter of the dummy layer fiber must fit the groove diameter, typically being smaller by a few micrometers than half the groove pitch. If the groove is smooth, the winding of the dummy layer may be done with any conventional technique, or by using the guiding helical ring disclosed in a co-pending application No. 154025 “Fiber-guiding helical ring” of the present inventor, which is incorporated herein in its entirety by reference. During the winding, the turns of the dummy layer are secured to each other using an adhesive inserted between and over the turns, the adhesive applied as well known in the art. After the winding is completed, the adhesive is cured, and the dummy layer is ready for further use as a guiding surface for the winding of the active optical fiber. Thus, the dummy layer of the present invention replaces as guiding grooved surface a pre-grooved tube surface. The dummy layer may be made of a fiber that is different from the active fiber, as long as their diameters are essentially equal. The only requirement is that the pitch of the dummy layer turns matches and accommodates the active fiber in the layer directly above the dummy layer. Advantageously, micro-bends, micro-cracks and other defects introduced by the bobbin surface into the dummy layer do not affect the quality and performance of the active layer wound on top of it, as described below.

Next, as shown in FIG. 3, an active optical fiber 60 is wound or “spooled” on top of dummy layer 50, guided by “grooves” 54 formed between adjacent turns of the dummy layer, and following the direction of the dummy layer winding. From this point on, the winding may follow any known procedure, including the procedure described in copending application No. 154025 “Fiber-guiding helical ring” of the present inventor, which is incorporated herein in its entirety by reference. The spooled active fiber has a significantly reduced density of micro-bends and micro-cracks in its first layer relative to an active fiber spooled directly on a grooved bobbin.

In summary, the use of a dummy layer instead of an active fiber layer as base (first layer) of a winding, provides a number of advantages, including:
1. the provision of physical separation between the bobbin tube and the active fiber, thus insulating the active fiber from any irregularity in the groove surface.
2. the reduction of optical losses in the active fiber, since micro-bends are now induced in a dummy layer instead of in the active fiber.
3. the presence of a more perfect winding surface for the active fiber.
4. the prevention of micro-cracks that can originate in the base layer of an active fiber and spread to other layers in the winding.

While the invention has been described with respect to a limited number of embodiments, it will be appreciated that many variations, modifications and other applications of the invention may be made.

1. A system for winding a defect-free active optical fiber on a bobbin, comprising:
a. a bobbin tube having an external surface; and
b. a dummy fiber layer overlaying said external surface and bound to said surface, whereby said dummy fiber layer serves as base layer for the active optical fiber.

2. The system of claim 1, wherein said external surface is smooth.

3. The system of claim 1, wherein said external surface is grooved, said dummy fiber overlaid in said groove.

4. A method for reducing winding-induced damage in an optical fiber wound on a bobbin having an external tubular surface, the method comprising the steps of:
a. winding a dummy fiber layer on the external tubular surface, said dummy layer serving as base layer for an active optical fiber; and
b. winding said active optical fiber over said dummy layer, whereby said dummy fiber guides said active fiber winding.

5. The method of claim 4, wherein said dummy fiber includes end turns, and wherein said step of winding a dummy fiber includes securing said end turns to said external surface.

6. The method of claim 4, wherein said external tubular surface is smooth.

7. The method of claim 4, wherein the external tubular surface is grooved, and wherein said step of winding a dummy fiber includes winding said dummy fiber in said groove.

8. The method of claim 4, wherein said dummy fiber and said active fiber are identical.

9. The method of claim 4, wherein said dummy fiber and said active fiber are different but characterized by an essentially identical diameter.
